(19) United States
(12) Patent Application Publication
(10) Pub. No.: US 2004/0085925 A1
(43) Pub. Date: May 6, 2004

(54) Method and system for managing a connection of a mobile element to a network

(76) Inventors: Fabio Longoni, Malaga (ES); Atte Lansisalmi, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/468,096

(22) PCT Filed: Feb. 15, 2001
(86) PCT No.: PCT/EP01/01706

(51) Int. Cl. H04Q 7/00

(52) U.S. Cl. 370/328

(57) ABSTRACT

The invention relates to a method and system for managing a connection of a mobile element to a network, the mobile element having at least one user plane connection for transmitting user traffic from and/or to the mobile element, and at least one control plane connection for signaling connection of the mobile element to a radio access network. When a relocation of the connection(s) of the mobile element is to be performed, only the user plane connection(s) is relocated, and the control plane connection(s) is maintained unchanged. The connections are Iu interface connections, i.e. the control plane is to an Iu control plane of a radio access controlling means, and the user plane is an Iu user plane of the radio access controlling means.

### FIELD AND BACKGROUND OF THE INVENTION

In current third generation mobile network, the connection between the Core Network (CN) and the Access Network (AN, or Radio Access Network, RAN) is effected via Iu interface. This applies at least for 3GPP UTRAN and GERAN RAN. The Iu interface consists of two separate instances, Iu-CS for the connection to the circuit switched core network domain, and the Iu-PS, for the connection to the packet switched core network domain. Both interfaces are composed by a control plane (CP) for the signaling (defined by the RANAP signaling protocol and the transport stack) and a user plane (UP) for the transfer of the user data—speech and data frames (defined by the Iu Frame Protocol and the transport stack).

When one Mobile Station (MS) is connected to the RAN, it has one signaling connection existing in the Iu CP (if the MS is connected to both the Iu-PS and Iu-CS, two signaling connections exist in the Iu CP). If MS has also one or more Radio Access Bearers (RAB=‘calls’) active, it has one or more user plane connections in Iu UP.

In the current UTRAN architecture, the Iu interface (both UP and CP protocols) terminates in the Radio Network Controller (RNC).

When the mobile element, e.g. MS or UE (User Equipment), moves in RAN, the Iu connection that is used by the mobile element possibly needs to be relocated, i.e. moved from one RNC to another RNC. This may e.g. happen if the cell(s) used by the mobile element are not under direct control of the RNC that terminates the Iu interface connection with the core network. As an example when the UE moves from a cell handled by a first RNC to a cell handled by a second RNC, the above mentioned relocation may become necessary. This relocation is supported by a set of procedure in the RANAS protocol (RANAP, SRNC relocation), and consists in moving both the control plane and user plane connection from a ‘source’ or ‘serving’ RNC to a ‘target’ RNC.

In the IP based RAN Architecture (for example an IP RAN Architecture that is targeted to be used as GERAN and new, enhanced UTRAN), the user plane and control plane of the Radio Controller (RNC, and BSC) are separated in different logical and most likely physical elements. This means that the Iu control plane terminates in one network element (referred to as the RAN Access Controller or Server, RNAS) and the Iu user plane terminates in another network element (referred to as the RAN Gateway, RNGW). The relocation may thus prove to be problematic or at least uneconomical or suboptimal.

### SUMMARY OF THE INVENTION

The present invention provides a method, system and mobile element as defined in the claims.

Generally, the invention provides a method and system for relocating the user plane of a CN-RAN connection in 3G network.

In detail, the method and/or system are adapted to manage a connection of a mobile element to a network, the mobile element having at least one user plane connection for transmitting user traffic from and/or to the mobile element, and at least one control plane connection for signaling connection of the mobile element to a radio access network, preferably an IP-based access network. When a relocation of the connection(s) of the mobile element is to be performed, only the user plane connection(s) is relocated, and the control plane connection(s) is maintained unchanged. The connections preferably are Iu interface connections, i.e. the control plane is an Iu control plane of a radio access controlling means, and the user plane is an Iu user plane of the radio access controlling means.

The user plane and the control plane may be connected to separate logical and even separate physical network elements.

With a distributed architecture in which the Iu control plane and the Iu user plane terminate in different network elements, the invention provides the possibility to relocate only the user plane connection (for example when the MS uses cells that are not easily connected to the used RNGW).

Specifically the advantages of relocating only the user plane are:

Only the user plane path will be optimized in order to have low use of transport resources. Since the amount of data transferred on the user plane is some orders of magnitude higher than the amount of data transferred on the control plane, relocation of the control plane is not necessary.

Relocation of the control plane is a critical process, because the UE RR state shall be frozen and transferred to the target RNC, and this has to be coordinated with Iu and RR (Radio Resource) signalling. Furthermore the relocation of the control plane would require extra signaling in air and Iu interface which is advantageously avoided.

If the RNGW should be, for any reason, overloaded, and cannot handle anymore all the user plane traffic (this can result from hardware failure, or from a situation in which the MS using the RNGW has requested a user plane connection that cannot be handled), the user control plane can be switched without switching the control plane.

The invention thus teaches the general idea of transferring the user plane connection, but leaving the control plane connection intact. This idea can preferably be implemented with reference to the Iu interface.

The relocation of only the user plane enhances the flexibility and scalability of the IP based distributed radio access network.

### BRIEF DESCRIPTION OF THE DRAWINGS

FIG. 1 shows an embodiment of a system structured and functioning in accordance with the present invention;

FIG. 2 illustrates an embodiment of a method and system in accordance with the present invention.

### DESCRIPTION OF PREFERRED EMBODIMENTS OF THE INVENTION

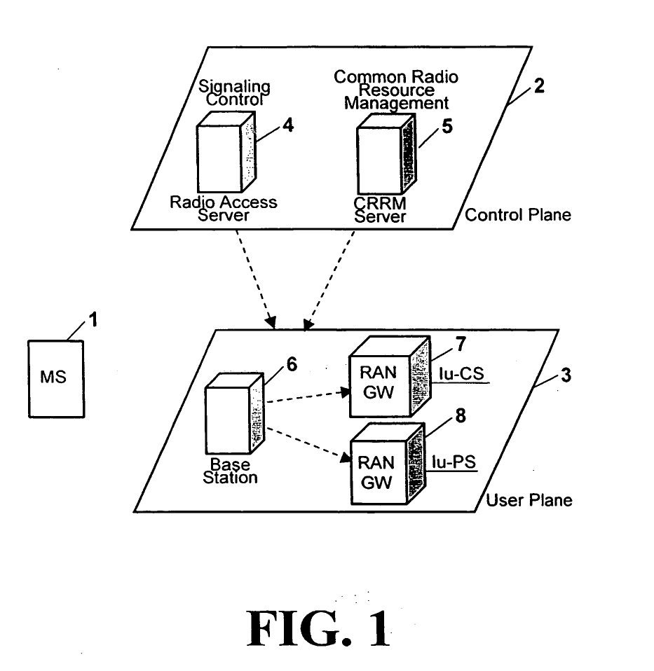

FIG. 1 shows an embodiment of the invention which includes one or more mobile stations (MSs) 1 being attachable to a communication network which comprises a control plane 2 and a separate user plane 3. The term mobile station as used here includes all types of mobile elements such as portable computers with data and/or voice transmission/receipt capability, mobile phones, portable user equipments and the like.

The control plane 2 comprises a Radio Access Server (RAS) 4 for signalling control of the connection and attachment of MS 1 to the network. The Iu control plane thus terminates in the Radio Access Server (RAS) 4. The control plane 2 furthermore comprises a server (CRRM server) 5 for common radio resource management.

The user plane 3 comprises one or more base stations 6, a RAN (Radio Access Network) Gateway (GW) 7 for Iu connection to a circuit switched (CS) network (not shown), as well as a RAN GW 8 for connection to a Packet Switched (PS) network (not shown). The RAN GW 8 provides an Iu connection to the Packet Switched (PS) network.

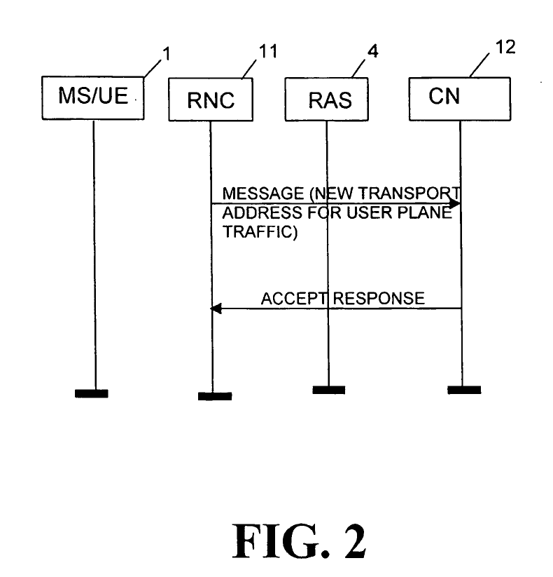

FIG. 2 shows a process flow and structure for performing a relocation procedure by relocating only the user plane connection (Iu user traffic connection) but maintaining the control plane connection unchanged.

As shown in FIG. 2, when a mobile station 1 possibly including a User Equipment (UE) is to be relocated e.g. because of movement of the MS 1, a Radio Network Controller RNC 11 (which may be a base station controller BSC or the like), sends a message to a Core Network (CN) 12 which message includes the new transport address for user plane traffic between MS 1 and the network. The CN 12 registers this new transport address for the user plane traffic of MS 1 and subsequently uses this new transport address for user traffic from and to MS 1.

The CN 12 may return a response message to the RNC 11 for informing them on acceptance of the new transport address (accept response).

The Iu connection of the signalling connection between MS 1 and RAS 4 is left unchanged as shown in FIG. 2 so that the connection to the control plane is maintained as before.

The invention provides several alternatives for relocating only the Iu user plane while keeping the Iu control plane termination unchanged.

One solution is to modify the current RANAP protocol in order to achieve this effect. This solution gives the RAN the possibility to decide on changing the transport address that terminates the Iu user plane interface.

The modification of the existing protocol can be done in several possible ways (with the first way being preferred):

A first way is shown in FIG. 2 as described above, and consists in providing a new procedure (e.g. termed “Intra RNS Relocation”). This procedure is for example initiated by the RNC 11 with a message to the relevant CN 12 domain, that includes the new transport addresses to be used for the user plane flows of one specific mobile station 1. The procedure is completed with a response message from the CN 12 to the RNC 11 (other messages may be provided).

As a second way, the current set of elementary procedures defining the RNS Relocation as defined in 3GPP Specifications may be modified in order to include the “Intra RNS relocation” as a particular case. This means that in the SRNS Relocation Request message the ‘Target RNC ID’ is not specified, and the message contains the information that the control plane address shall not be changed. The procedure then is executed as in the normal case. Thus, an SRNS Relocation Request message sent during RNS Relocation procedure contains information indicating that the control plane address shall not be changed. This information in the message may e.g. consist of one of the following alternatives: The message does not contain a field with target ID. Alternatively, the information may be a field indicating: target ID=Source ID. The information may also be an explicit parameter indicating “do not change Control plane”.

Further, a procedure for RAB Reconfiguration Request may be used. This procedure may indicate from the RNS to the CN that there is a need to reconfigure the QoS characteristics of an existing RAB. This procedure may be used to indicate only the need to change the IP address (possibly also GTP TEID=GPRS Tunnel Endpoint Identifier) in the DL (downlink) direction. The CN may then run the RAB Assignment procedure, again to only change DL IP address (possibly also GTP TEID), to switch the DL connection for U-Plane, while the C-Plane connection remains.

When implementing these changes, the effect is to relocate the user plane only, thus enhancing the flexibility and scalability of the IP based distributed radio access network.

The invention provides the possibility for a radio access network to anchor the control plane connection to the CN, and relocate only the user plane. This is possible because of the separation between user plane and control plane on the Iu interface.

The Iu user plane relocation is a beneficial feature in IP RAN products.

The relocating of the user plane of the CN-RAN connection can be provided for a 3G network and also in networks of various other types, e.g. in IM, GPRS and UMTS domains.

Although the invention has been described above with reference to specific embodiments, the scope of protection of the invention intends to also cover all modifications, omissions, additions and amendments of the disclosed features.

1. Method for managing a connection of a mobile element to a network, the mobile element having at least one user plane connection for transmitting user traffic from and/or to the mobile element, and at least one control plane connection for signaling connection of the mobile element to a radio access network, wherein, when a relocation of the connection(s) of the mobile element is to be performed, only the user plane connection(s) is relocated, and the control plane connection(s) is maintained unchanged.

2. Method according to claim 1, wherein the connections are Iu interface connections.

3. Method according to claim 1 or 2, wherein the control plane is to an Iu control plane of a radio access controlling means, and the user plane is an Iu user plane of the radio access controlling means.

4. Method according to any one of the preceding claims, wherein the user plane and the control plane are connected to separate logical elements.

5. Method according to any one of the preceding claims, wherein the user plane and the control plane are connected to separate physical network elements.

6. Method according to any one of the preceding claims, wherein the radio access network is an IP-based access network.

7. Method according to any one of the preceding claims, wherein a user plane connection relocation procedure is initiated by a control element sending a message to a Core Network (CN) domain, the message including at least one new transport address to be used for the user plane traffic of the mobile element.

8. Method according to claim 7, wherein the procedure is completed with a response message from the Core Network to the control element.

9. Method according to any one of claims 1 to 6, wherein an SRNS Relocation Request message sent during RNS Relocation procedure contains information indicating that the control plane address shall not be changed.

10. Method according to any one of claims 1 to 6, wherein a procedure for RAB Reconfiguration is used wherein a control means (RNS) indicates to the Core Network that there is a need to reconfigure the QoS characteristics of an existing Radio Access Bearer (RAB), wherein the procedure indicates the need to change the IP address in the downlink direction, the Core Network then performing a RAB Assignment procedure to change only the downlink IP address for switching the downlink connection for the user plane, while the control plane connection is maintained.

11. Method according to claim 10, wherein the procedure additionally changes the downlink GTP TEID (GPRS Tunnel Endpoint Identifier).

12. System for managing a connection of a mobile element to a network, the mobile element being adapted to have, when connected to the network, at least one user plane connection for transmitting user traffic from and/or to the mobile element, and at least one control plane connection for signaling connection of the mobile element to a radio access network, wherein the system is adapted to relocate, when a relocation of the connection(s) of the mobile element is to be performed, only the user plane connection(s), and to maintain the control plane connection(s) unchanged.

13. System according to claim 12, wherein the connections are Iu interface connections.

14. System according to claim 12 or 13, wherein the control plane is to an Iu control plane of a radio access controlling means, and the user plane is an Iu user plane of the radio access controlling means.

15. System according to any one of the preceding system claims, wherein the user plane and the control plane are connected to separate logical elements.

16. System according to any one of the preceding system claims, wherein the user plane and the control plane are connected to separate physical network elements.

17. System according to any one of the preceding system claims, wherein the radio access network is an IP-based access network.

18. System according to any one of the preceding system claims, comprising a control element for initiating a user plane connection relocation procedure by sending a message to a Core Network (CN) domain, the message including at least one new transport address to be used for the user plane traffic of the mobile element.

19. System according to claim 16, wherein the procedure is completed with a response message from the Core Network to the control element.

20. System according to any one of claims 12 to 17, wherein an SRNS Relocation Request message sent during RNS Relocation procedure contains information indicating that the control plane address shall not be changed.

21. System according to any one of claims 12 to 17, comprising a control means for performing a procedure for Radio Access Bearer (RAB) Reconfiguration when a relocation of the user plane connection(s) is to be performed, wherein the control means is adapted to indicate to the Core Network that there is a need to reconfigure the QoS characteristics of an existing RAB, the procedure being implemented to indicate the need to change the IP address in the downlink direction, the Core Network being adapted to respond by then performing a RAB Assignment procedure to change only the downlink IP address for switching the downlink connection for the user plane, while the control plane connection is maintained.
